(19) United States
(12) Patent Application Publication
(10) Pub. No.: US 2008/0162280 A1
(43) Pub. Date: Jul. 3, 2008

(54) Rebate processing tool

(76) Inventors: Rita Marie Jacobs, Morton, IL (US); Eng Tze Oh, Peoria, IL (US); Richard Loy Gillaspie, Peoria, IL (US); Jason Scott Kern, St. Martin D'Uriage (FR); Samuel Edward Cooper, Morton, IL (US); Kurt Arthur Norris, Snoqualmie, WA (US); Andrew Sanders Trent, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/646,546

(22) Filed: Dec. 28, 2006

(51) Int. Cl. G06Q 30/00

(52) U.S. Cl. 705/14

(57) ABSTRACT

A computer system for a rebate processing tool is provided. The computer system has a platform, at least one input device, and a central processing unit in communication with the platform and the at least one input device. The central processing unit is configured to receive, at a computer, a claim for one or more rebate programs and determine, by the computer, whether the claim satisfies one or more predetermined conditions. The central processing unit is also configured to approve the claim upon satisfaction of the predetermined conditions. The central processing unit is further configured to review the claim when at least one of the predetermined conditions is not satisfied.

### TECHNICAL FIELD

The present disclosure is directed to the field of rebates and, more particularly, to a rebate processing tool.

### BACKGROUND

Companies often provide incentives to customers to purchase products. For example, companies might provide rebates that refund a portion of the purchase price or extend a product warranty. To obtain the refund, a customer may mail a rebate form, a product code, and a receipt to the company, which may evaluate the rebate and, if the rebate is valid, mail a check to the customer. Some companies utilize independent dealers to sell and deliver products to customers. In this situation, the dealer may provide a rebate to a customer at the time of purchase, and the dealer may request reimbursement for the rebate from the parent company.

While these rebate programs may increase product sales, they often frustrate customers, dealers, and companies. Completing a rebate form and mailing it to a company, either by the customer or a dealer, takes time and costs money. The customer or dealer must then wait while the company processes the rebate and issues a rebate check. Issuing a rebate check can take months or even longer because the company must review each rebate request. In addition, the company must hire employees to perform this review, which increases the costs of the rebate program and may lead to errors. For example, an employee may inadvertently pay a rebate for the same product twice, or may incorrectly determine the amount of a rebate. Companies also must wait until the customer or dealer requests the rebate before the company can determine the success of a rebate program. This uncertainty can cause problems with maintaining accurate accounting records, determining sales revenue, and determining the costs of a rebate program. For example, some dealers may wait until the fourth quarter of a year to request rebates, causing the parent company's revenue to decline at the end of the year. Companies therefore would like to promptly receive rebate requests and automatically issue refunds for the rebates.

One tool that has been developed for processing rebates is U.S. Pat. No. 6,847,935 by Solomon et al. (the '935 patent). The '935 patent describes a system and method for computer-aided rebate processing. The system includes a network that connects a central rebate processing center, a manufacturer, a distributor, and a consumer. A consumer may browse available rebates, print a rebate request form, and mail the request form, receipt, and other material that verifies a product purchase to a processing interface. The processing interface provides the request form to the rebate processing center. Alternatively, a customer can scan images of receipts and product codes and electronically transmit them to the rebate processing center. The rebate processing center determines whether the rebate is valid and, if the rebate is valid, authorizes payment of the rebate to the customer. The '935 patent also tracks rebate performance statistics to monitor a rebate's effectiveness.

Although the tool of the '935 patent may offer centralized rebate processing and performance monitoring, it fails to ensure prompt receipt and processing of rebates. In particular, the '935 patent still requires customers to mail or scan and transmit rebate information to a rebate processing center. If a customer mails the rebate information to the rebate processing center, an employee at the rebate processing center must open the mail, review the rebate form, create an entry in a transaction table, and create a transaction identifier for processing the rebate. If a customer scans and electronically transmits the rebate information to the rebate processing center, an employee must once again open the scanned images, review these images, create an entry in a transaction table, and create a transaction identifier. Requiring employees to review rebate requests increases costs and increases the amount of time required to process a rebate. The '935 patent therefore does not provide a method for automatically processing and fulfilling rebates because employees must manually receive the rebate request and provide the necessary information to the rebate processing center. Accordingly, the method employed by the '935 patent can cause delays in processing rebates that may frustrate customers, dealers, and companies.

The present disclosure is directed to overcoming one or more of the problems set forth above.

### SUMMARY OF THE INVENTION

In accordance with one aspect, the present disclosure is directed toward a computer readable medium, tangibly embodied, including a rebate processing tool. The computer readable medium includes instructions for receiving, at a computer, a claim for one or more rebate programs and determining, by the computer, whether the claim satisfies one or more predetermined conditions. The computer readable medium also includes instructions for approving the claim upon satisfaction of the predetermined conditions. The computer readable medium further includes instructions for reviewing the claim when at least one of the predetermined conditions is not satisfied.

According to another aspect, the present disclosure is directed toward a method for providing a rebate processing tool. The method includes receiving, at a computer, a claim for one or more rebate programs and determining, by the computer, whether the claim satisfies one or more predetermined conditions. The method also includes approving the claim upon satisfaction of the predetermined conditions. The method further includes reviewing the claim when at least one of the predetermined conditions is not satisfied.

According to another aspect, the present disclosure is directed to a computer system including a platform, at least one input device, and a central processing unit in communication with the platform and the at least one input device. The central processing unit is configured to receive, at a computer, a claim for one or more rebate programs and determine, by the computer, whether the claim satisfies one or more predetermined conditions. The central processing unit is also configured to approve the claim upon satisfaction of the predetermined conditions. The central processing unit is further configured to review the claim when at least one of the predetermined conditions is not satisfied.

### BRIEF DESCRIPTION OF THE DRAWINGS

FIG. 1 is a block illustration of an exemplary disclosed rebate processing system;

FIG. 2 is a flowchart illustration of an exemplary disclosed method of processing rebates; and

FIG. 3 is a schematic illustration of an exemplary disclosed web interface providing a rebate processing tool.

### DETAILED DESCRIPTION

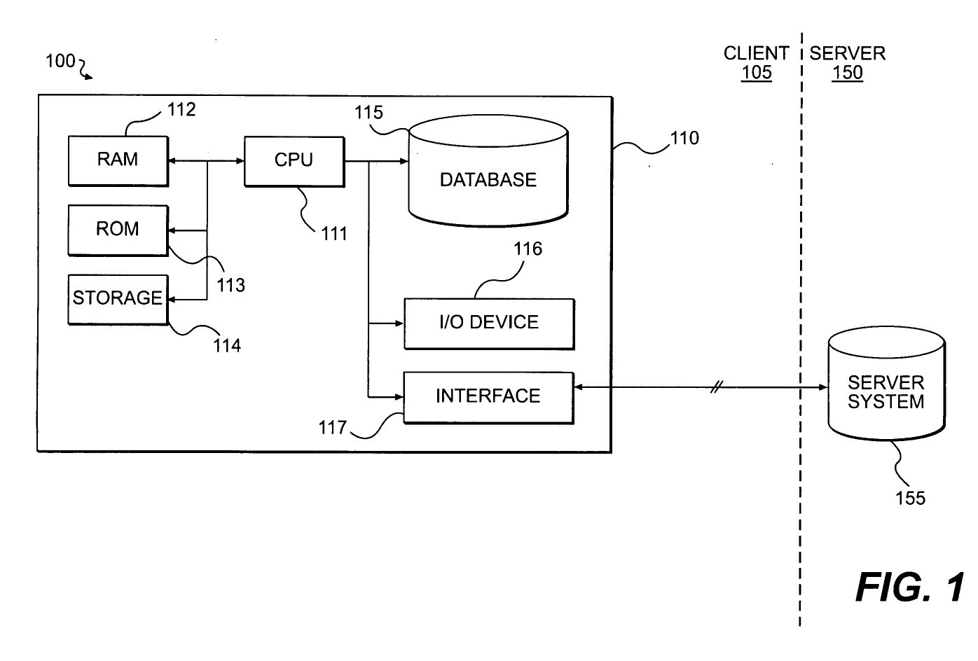

FIG. 1 provides a block diagram illustrating an exemplary disclosed rebate processing environment 100. Rebate processing environment 100 may include a client 105 and server 150. Client 105 may include one or more systems 110 for generating a claim for a rebate, and server 150 may include one or more server databases 155 for processing the claim. Client 105 may be, for example, a customer or a dealer that sells products of a parent company. Server 150 may be, for example, a parent company that offers rebate programs to customers and dealers. Although illustrated as a single client 105 and a single server 150, a plurality of clients 105 may be connected to either a single, centralized server 150 or a plurality of distributed servers 150.

System 110 may include any type of processor-based system on which processes and methods consistent with the disclosed embodiments may be implemented. For example, as illustrated in FIG. 1, system 110 may include one or more hardware and/or software components configured to execute software programs. System 110 may include one or more hardware components such as a central processing unit (CPU) 111, a random access memory (RAM) module 112, a read-only memory (ROM) module 113, a storage 114, a database 115, one or more input/output (I/O) devices 116, and an interface 117. System 110 may include one or more software components such as a computer-readable medium including computer-executable instructions for performing methods consistent with certain disclosed embodiments. One or more of the hardware components listed above may be implemented using software. For example, storage 114 may include a software partition associated with one or more other hardware components of system 110. System 110 may include additional, fewer, and/or different components than those listed above, as the components listed above are exemplary only and not intended to be limiting.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and CPU 111. RAM 112 may include a memory device for storing data associated with one or more operations of CPU 111. For example, ROM 113 may load instructions into RAM 112 for execution by CPU 111. ROM 113 may include a memory device configured to access and store information associated with system 110, including information for identifying, initializing, and monitoring the operation of one or more components and subsystems of system 110.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and CPU 111. For example, database 115 may include historical data, such as current inventory of products and past sales of products, past claims for rebates, accounting information, and other information that a dealer of products may need to operate their business. CPU 111 may access the information stored in database 115 for generating a claim for a rebate program by retrieving, for example, the date of a sale, the product sold, the product serial code, and other information necessary to generate the claim, as described below. CPU 111 may also analyze current and previous inventory, claims for rebates, and received rebates to identify trends in sales history and rebate processing. These trends may then be recorded and analyzed to ensure prompt submission of claims and receipt of rebate payments from server 150.

I/O devices 116 may include one or more components configured to communicate information with a user associated with system 110. For example, I/O devices may include a console with an integrated keyboard and mouse to allow a user to input parameters associated with system 110. I/O devices 116 may also include a display, such as a monitor, including a graphical user interface (GUI) for outputting information. I/O devices 116 may also include peripheral devices such as, for example, a printer for printing information and reports associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

The results of received data may be provided as an output from system 110 to I/O device 116 for printed display, viewing, and/or further communication to other system devices. Such an output may include, for example, accounting reports, claims for rebate programs, claim receipt confirmations from server 150, lists of rebate programs, customer lists, and reports relating to inventory of a dealer. Output from system 110 can also be provided to database 115 and to server system 155 to track historical inventory, sales, claims for rebates, and received refunds for rebates.

Interface 117 may include one or more components configured to transmit and receive data via a communication network, such as the Internet, a local area network, a workstation peer-to-peer network, a direct link network, a wireless network, or any other suitable communication platform. In this manner, system 110 and server system 155 may communicate through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 117 may include one or more modulators, demodulators, multiplexers, demultiplexers, network communication devices, wireless devices, antennas, modems, and any other type of device configured to enable data communication via a communication network.

System 110 may manage inventory levels of a dealer, monitor sales of products to consumers, generate claims for one or more rebate programs, and submit the claims to server 150. System 110 may display all rebate programs, display eligible rebate programs based on sales information, and allow completion of a claim for one or more rebate programs.

Server 150 may be associated with a manufacturer, supplier, or distributor of one or more products that client 105 sells or uses in business. For example, if client 105 offers maintenance and repair of vehicles, server 150 may be associated with the manufacturer of the vehicles that client 105 maintains. Additionally, server 150 may be associated with a manufacturer of a part used by the vehicles that client 105 maintains.

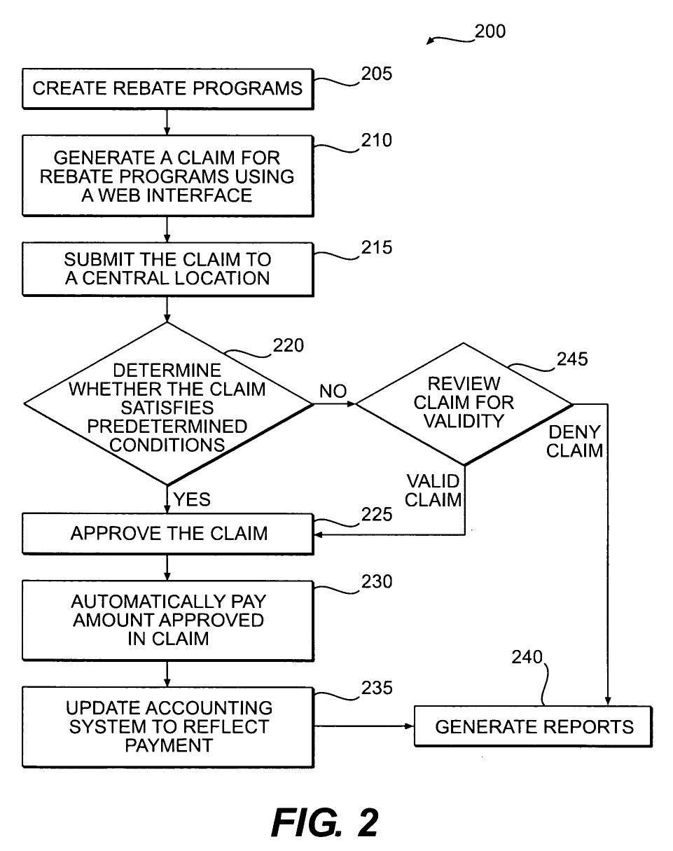

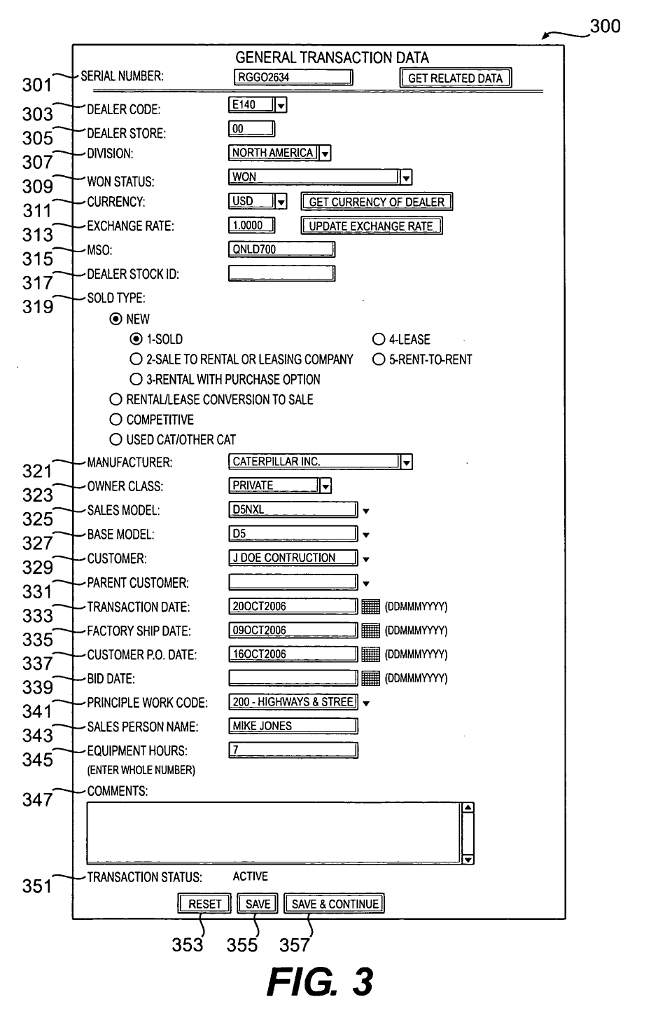

Server system 155 may provide a web interface to client 105 for generating a claim for one or more rebate programs. Server system 155 may allow creation of rebate programs, provide a list of rebate programs to client 105, receive a claim for one or more of the rebate programs from client 105, determine whether the claim satisfies one or more predetermined conditions, approve the claim upon satisfaction of the predetermined conditions, and request review of the claim when at least one of the predetermined conditions is not satisfied. These steps that server system 155 may perform, as well as the predetermined conditions and other information for processing claims for rebate programs, will be described in more detail below with reference to FIGS. 2 and 3. Although not illustrated, server system 155 may include similar components as described above with respect to client system 110.

Those skilled in the art will appreciate that all or part of systems and methods consistent with the present disclosure may be stored on or read from other computer-readable media. Rebate processing environment 100 may include a computer-readable medium having stored thereon machine executable instructions for performing, among other things, the methods disclosed herein. Exemplary computer readable media may include secondary storage devices, like hard disks, floppy disks, and CD-ROM; or other forms of computer-readable memory, such as read-only memory (ROM) 113 or random-access memory (RAM) 112. Such computer-readable media may be embodied by one or more components of rebate processing environment 100, such as CPU 111, storage 113, database 115, server system 155, or combinations of these and other components.

Furthermore, one skilled in the art will also realize that the processes illustrated in this description may be implemented in a variety of ways and include other modules, programs, applications, scripts, processes, threads, or code sections that may all functionally interrelate with each other to accomplish the individual tasks described above for each module, script, and daemon. For example, these programs modules may be implemented using commercially available software tools, using custom object-oriented code written in the C++ programming language, using applets written in the Java programming language, or may be implemented with discrete electrical components or as one or more hardwired application specific integrated circuits (ASIC) that are custom designed for this purpose.

The described implementation may include a particular network configuration but embodiments of the present disclosure may be implemented in a variety of data communication network environments using software, hardware, or a combination of hardware and software to provide the processing functions.

Processes and methods consistent with the disclosed embodiments may quickly process claims for rebate programs and reduce costs associated with processing rebates. As a result, customers or dealers may receive their refund for the rebate faster, companies may monitor and track the success of rebate programs, and companies may ensure accurate accounting through prompt submission and processing of claims for rebates. Exemplary processes and methods consistent with the invention will now be described with reference to FIGS. 2 and 3.

### INDUSTRIAL APPLICABILITY

The disclosed method and system may provide an efficient rebate processing tool. In particular, the disclosed method and system may be used to implement a rebate processing tool that allows a dealer to request a rebate from a parent company using a web interface and promptly have the claim processed. The rebate processing tool allows dealers and companies to maintain accurate, updated accounting records, monitor success rates of rebate programs, determine the status of one or more claims for rebates, and satisfy reporting obligations, such as regulatory accounting requirements. Dealers and companies may perform these exemplary functions of the disclosed rebate processing tool using a user-friendly, web-based interface.

FIG. 2 illustrates a flowchart illustration of an exemplary disclosed method 200 performed by a rebate processing tool. The first step in the functioning of the rebate processing tool may include creating rebate programs (Step 205). Companies that want to improve sales or offer incentives to customers may create rebate programs for different products. The company may employ marketing research, feedback from dealers, analysis of current or previous rebate programs, and projected sales forecasts to determine which products should have a rebate program. For example, a company may be introducing an updated product model that includes substantial upgrades and changes to a current product model. In this situation, the company may offer rebate programs to customers for the current product model to reduce inventory in anticipation of the updated product model. In designing the rebate program, the company may define one or more predetermined conditions for obtaining a rebate. Exemplary conditions include a beginning and an end date between which a customer must purchase the product, the particular model of a product sold, whether the customer purchased accessories with the product, the form of payment, the type of transaction (e.g., sale, lease, rent), the sales price, and other conditions as designated by the creator of the rebate program. An example of predetermined conditions in a rebate program will be described in more detail below with reference to FIG. 3.

Next, a dealer may generate a claim for one or more rebate programs using a web interface at client 105 (Step 210). A claim may include one or more rebate programs because multiple rebate programs may be available to a customer for a particular transaction. The dealer may generate a claim for one or more rebate programs at the time of the transaction. Alternatively, the dealer may generate a claim for a rebate at a later time, such as at the end of a month. One of the predetermined conditions, however, may be that a dealer submits a claim for a rebate program within a certain period of time after the sale, such as sixty days, although any other period of time may be specified for a given rebate program. By requiring the dealer to promptly submit claims for rebates, the company can ensure that accounting records are updated, determine costs associated with the rebate program, and modify or remove the rebate program based on its success. A dealer may submit the claim at the same time or after the dealer submits a separate sales report to the parent company. The parent company may use the sales report to, for example, track past sales and forecast warranty obligations.

The web interface for generating a claim may be a user-friendly interface available over the Internet and may assist a dealer in creating a claim. For example, the web interface may display a list of all available rebate programs, or only rebate programs that are available for the dealer generating the claim. The dealer may then search for a subset of eligible rebate programs based on information in the claim. For example, if a dealer enters a particular model number in a claim, such as a 740 Ejector Truck, the web interface may provide the dealer with a subset of rebate programs that are available to that dealer for the 740 Ejector Truck. A dealer may also search for a subset of rebate programs based on date range during which a product was sold, the type of transaction (e.g., sale, lease, rental), the type of customer (e.g., private or government), type of rebate (e.g., special financing or refund of purchase price), and other criteria that a dealer can use to identify eligible rebate programs for a particular transaction. Dealers may also search for rebate programs prior to a sale to determine what rebate programs are available for customers, or after submission of a claim to determine the claim's status.

The web interface may identify the subset of rebate programs within the list of all available rebate programs or by displaying a separate list which includes only the rebate programs in the subset. If a dealer chooses to view the subset of eligible rebate programs within the list of all available rebate programs, the web interface may distinguish the rebate programs in the subset from other rebate programs. For example, the web interface may use different colors for rebate programs included in the subset, bold rebate programs included in the subset, or make only rebate programs included in the subset selectable by a user. The web interface may also narrow the list of eligible rebate programs once a user selects a first rebate program. For example, a particular product may have more than one available rebate program, such as an extended warranty, a refund for a portion of the purchase price, and a reduced interest rate for financing the purchase of the product. If a customer chooses the extended warranty, the rebate programs for a refund of the purchase price or reduced interest rate may be not be available. Although these exemplary rebate programs have been described, additional types of rebate programs that provide incentives to customers to purchase products may also be used.

Once a dealer selects the rebate programs to include in the claim, the dealer may complete the claim using the web interface. Alternatively, a dealer may first complete the transaction information for a claim, and then select the rebate programs to include in the claim. An exemplary web interface for generating a claim will be described below with reference to FIG. 3.

After generating a claim for one or more rebate programs, the dealer may submit the claim from client 105 to a central location, such as server system 155 (Step 215). The dealer may submit the claim with other claims and sales records. Server system 155 may review the received claims for accuracy and display, using the web interface, any error messages or warnings to the dealer. For example, if a dealer does not enter a model number for the product sold, an error message may be displayed that prompts the dealer to provide a model number; and if a dealer does not enter a salesperson who sold the product, a warning message may be displayed. A dealer may choose to ignore these errors messages and warnings and finalize submission of the claim, but doing so may require that the claim be manually reviewed by an employee of the company (as described below).

After receiving the claim, server system 155 may determine whether the claim satisfies the predetermined conditions defined by a creator of the rebate program (Step 220). One exemplary predetermined condition is whether the product was sold between a beginning and an end date of the rebate program. If the product was not sold within the rebate program's date range, this predetermined condition may fail. Another exemplary predetermined condition is the amount of the sale. Server system 155 may analyze the amount of sale to determine, for example, whether the amount of sale meets a minimum amount required by the rebate program. Yet another exemplary predetermined condition includes the amount of rebate requested by a dealer. If a dealer requests a rebate amount that exceeds a maximum amount (e.g., $10,000), server system 155 may require manual review of the claim. Setting a maximum amount that server system 155 may automatically pay reduces the risk of a dealer accidentally or fraudulently requesting large sums of money that are improper for the rebate programs included in the claim. However, the rebate amount may also be automatically filled in for the dealer based on other information included in the claim, as described in more detail below. Additional predetermined conditions include the type of transaction (e.g., a rebate program may only be available for sales rather than leases); the dealer that sold the product (e.g., rebate programs may only be offered in certain regions); the type of customer (e.g., rebate programs may only be available to private customers rather than governmental customers); the product model; the product serial number (e.g., a rebate may only be available for some configurations of a product model and only once for each unique product); a compatibility check (e.g., whether the dealer requested refund for a mutually exclusive rebate program that cannot be processed with another rebate program, either previously or in the same claim); the particular customer (e.g., rebates may be available for customers that frequently purchase products); and other conditions as defined during creation of a rebate program.

If the claim satisfies all of the predetermined conditions, server system 155 may automatically approve the claim (Step 225). “Automatically” includes without requiring review by a person. Once server system 155 approves a claim, the claim status may be updated to “pending payment,” and the dealer that submitted the claim may be notified of the approval. For example, server system 155 may automatically send an e-mail to the dealer indicating server system 155 approved the claim. Additional examples of claim statuses will be described below.

After approving the claim, server system 155 may automatically pay the amount approved in the claim (Step 230). The claim may be automatically paid, for example, by wire transfer to a dealer using a currency appropriate for the dealer, or by reducing an amount that the dealer owes the company. The claim may be paid within a certain amount of time, such as two days, to ensure prompt refund to the dealer and improve the dealer's cash flow. Claims that are automatically paid may be randomly audited, either at the selection of a user or periodically, to ensure that dealers are not generating fraudulent claims. Auditing may also identify claims that server system 155 approved and paid, but should be refunded because the customer returned the product after the sale. The claims included in the audit may be randomly selected by server system 155 and may include one or more claims from each dealer during the audit period.

Next, server system 155 and the dealer may update their respective accounting systems to reflect the payment, with server system 155 indicating an amount paid and the dealer indicating an amount received (Step 235). Server system 155 may store information related to the claim, such as the product serial number, to ensure that duplicative claims for the same product are not paid at a later time. This process of updating the accounting systems may be performed automatically at the time of payment or periodically, such as once every week. The updating period may also be defined by a user to ensure compliance with regulatory reporting obligations.

A dealer or company may use the information stored in the accounting systems to generate reports regarding, for example, the success of rebate programs and the amounts refunded under the rebate programs (Step 240). A company may duplicate successful rebate programs, such as those rebate programs that increase the sales of products, and offer those rebate programs to other dealers or distribution regions. These reports may also indicate the number and types of products that each dealer sold, any errors or warnings that a dealer received upon submission of their claim, the reasons for requiring manual review of a claim, the reasons for denying a claim, and the amount of time required to process a claim. A dealer or company may generate a report of all rebates for particular customer; generate a report regarding the transaction status of claims; generate a report based on any of other field included in a claim; and generate reports for all claims within a designated period of time. Exemplary fields of a claim and transaction statuses will be described below with reference to FIG. 3. The amount of access and types of reports that a user can access may vary depending, for example, on the amount of authorization granted to the user. A user may generate the reports using a web interface provided by rebate processing environment 100.

Returning to step 220, if the claim does not satisfy one or more of the predetermined conditions, the claim may be reviewed for validity (Step 245). Server system 155 may automatically generate an e-mail to the creator of the rebate program that the dealer requested. The creator may review the claim, contact the dealer to obtain updated information or information the dealer forgot to include in the claim, and review the predetermined conditions to ensure that the claim is valid. The creator of a rebate program may create an exception that makes the claim valid even if one or more of the predetermined conditions is not satisfied. For example, the creator of a program may decide to extend the ending date of a rebate program. If the creator determines that the claim is valid, the claim may be approved (Step 225). If, however, the creator denies the claim, the denial may be recorded by server system 155 and the process may proceed to generating reports (Step 240). The dealer may be automatically notified, such as by e-mail, that their claim will be reviewed and that the creator of the rebate program approved or denied their claim. A dealer may re-submit their claim after correcting the errors that caused the creator of the rebate program to deny the claim.

FIG. 3 illustrates an exemplary user interface 300 that a dealer may use to generate and submit claims for rebate programs. The fields 301-351 included in user interface 300 may vary depending on the predetermined conditions for the selected rebate program(s). One or more of the fields may be required, while other fields may be optional. User interface 300 may indicate required fields by, for example, placing an asterisk by the field description. Collectively, the information in fields 301-351 may be used to determine whether a claim satisfies the predetermined conditions, to determine whether server system 155 should approve the claim, to generate reports, to update accounting records, and to monitor the success of rebate programs.

As illustrated at field 301, a user may enter the serial number of a product included in the transaction. Once a user enters a serial number, the user may select to “get related data”. The get related data option will automatically fill in many of the fields in user interface 300 and also store other data associated with the serial number in one or more databases. For example, dealer code 303, dealer store 305, division 307, manufacturer 321, sales model 325, base model 327, and factory ship date 335 may be automatically completed for the dealer based on dealer log-in information and information stored by server database 155. Fields that are not automatically completed may be highlighted or otherwise distinguished so that a user can easily identified required information.

Fields 303-307 may identify a dealer and the dealer's location. Dealer code 303 may be a designation given to a dealer by the parent company, and may represent an individual dealer as well as any branches of the dealer. A user may designate which branch of a dealer sold the product using dealer store 305. For example, a dealer may include three branches, with a dealer code “E140,” a dealer store “00” for the main branch, dealer store “01” for the second branch, and dealer store “02” for the third branch. Division 307 may identify the division of a dealer within the parent company. A company may use one or more distribution divisions throughout the world, such as North America, South America, Europe, Asia, and Southern Pacific. In the example of FIG. 3, the dealer is in the North American division 307. Although three exemplary fields have been described for identifying a dealer and a dealer's location, additional fields may also be used, such as an address.

Won status 309 may indicate whether the dealer sold the product. If a dealer did sell the product, won status 309 may be “won”; if a dealer did not sell a product, won status 309 may be “lost”; and if a dealer is still negotiating the sale, won status 309 may be “pending”. Dealers may complete the fields of user interface 300 for sales that were lost or pending to report information to the company that may be helpful for marketing. For example, if a company receives a significant number of “lost” deals for a particular product, the company may decide to create a rebate program as an incentive for customers to purchase that product.

Currency 311 may indicate the currency used for the transaction. Currency 311 may be automatically completed by selecting “get a currency of dealer”. Similarly, exchange rate 313 may be automatically updated for a dealer by selecting “update exchange rate”. Server system 155 may store the currencies and exchange rates in a table and retrieve information for these fields based on, for example, dealer code 303.

MSO 315 may indicate a machine supply order number. When a dealer places an order for a product from a company, the company may generate MSO 315 to track the order. The product serial number 301 used to fulfill the order may be stored with MSO 315 to facilitate auto-completion of user interface 300 when a dealer generates a claim for one or more rebate programs.

Dealer stock ID 317 may be the dealer stock number for the product in the transaction. Dealers may use stock identifiers to monitor and count inventory. Because dealers also have the ability to generate and view reports regarding past transactions, dealer stock ID 317 may assist a dealer in creating custom reports for their needs.

Sold type 319 may indicate the type of transaction for the product. Exemplary sold types 319 include new, rental/lease conversion to sale, competitive, and used CAT®/other CAT®. New sales may include sold to indicate a sale to the consumer, sale to rental or leasing company, rental with purchase option, lease, and rent-to-rent (when customers rent a product for short periods of time). A rental/lease conversion to sale may occur when a customer purchases the product during or at the end of a rental or lease period. A competitive sold type indicates that the dealer sold a competitor's product. Indicating a competitive sale may aid the company in determining which products should have rebate programs. Moreover, sometimes a company may offer a rebate program for a competitor's product to assist a dealer in reducing inventory when customers trade a competitor's product in for a product manufactured by the company. A used CAT®/other CAT® sold type indicates that the customer purchased a used Caterpillar® product or Caterpillar® accessory, where the exemplary company is Caterpillar®, Inc.

Manufacturer 321 indicates the manufacturer of the product sold. Manufacturer 321 may be, for example, the parent company, a company that sells accessory products for the parent company (e.g., replacement tires used for a vehicle produced by the company), a division of the parent company that is branded under another trade name, or a competitor of the company.

Owner class 323 may indicate the type of customer that purchased the product. Two exemplary owner classes are private and governmental. Each owner class may also include additional sub-classes; for example, the governmental owner class may include national, state, military, municipal, etc.

Sales model 325 may indicate the sales model of the product involved in the transaction. Base model 327 may indicate a more general category that encompasses the sales model. For example, base model 327 may be D5 to indicate a track-type tractor and sales model 325 may be D5NXL, a specific track-type tractor.

Customer 329 may be the customer that purchased the product. Parent customer 331 may indicate whether another company owns customer 329. For example, if a customer Mega Corporation owns John Doe Construction and Jane Doe Construction, customer 329 may be John Doe Construction, and parent customer 331 may be Mega Corporation.

Transaction date 333 may be the date the dealer sold the product to customer 329, and factory ship date 335 may be the date the company shipped the product to the dealer. The company and dealer can determine how long a dealer holds a product in inventory prior to sale by subtracting the factory ship date 335 from the transaction date 333 and accounting for shipping time. Customer P.O. date 337 may indicate the date on which a customer placed a purchase order. For example, assume parent customer 331 provides subsidiary customer 329 with a purchase order on Nov. 16, 2006 to obtain a BackHoe Loader 420E, and customer 329 purchases the product from a dealer on Nov. 18, 2006. In this example, customer P.O. date 337 would be Nov. 16, 2006 and transaction date 333 would be Nov. 18, 2006.

Bid date 339 may be the date on which the dealer placed a bid to sell the product. For example, government customers may request that dealers bid to sell their products. The government may then purchase the product with the lowest bid. Bid date 339 may be the date that the dealer submits the bid to the customer, in this example a government customer.

Principle work code 341 may indicate the type of industry in which a customer will use the product. For example, principle work code 341 may be pipeline installation, home construction, or road construction. A sales person 343 may ask the customer what type of industry the product will be used in to identify the principle work code 341. However, principle work code 341 may also be automatically filled in if the dealer previously submitted principle work code 341 with a sales report.

Equipment hours 345 may indicate a duration, such as a number of hours, that users have operated a product. Instead of, or in addition to, equipment hours 345, any other time or distance (e.g., mileage) may be used to indicate the duration that users have operated the product.

Comments 347 may be any additional information regarding the sale that a dealer may want to provide to a company. For example, if a sales person quit after selling the product, a dealer may indicate in comments 347 that the sales person no longer works for the dealer. A dealer may also provide comments regarding, for example, why the customer purchased a competitors product and whether a rebate program was required to obtain the sale.

Transaction status 351 may indicate the progress in generating and submitting a claim to server system 155. For example, transaction status 351 may be “active” while a dealer completes the fields in user interface 300, “pending verification” if server system 155 received the claim and is determining whether the claim satisfies the predetermined conditions (FIG. 2, Step 220), “under review” if a claim is under review (FIG. 2, Step 245), “pending payment” if server system 155 approved the claim but has not yet made payment (FIG. 2, Step 225), “paid” if server system 155 approved the claim and the dealer received the payment (FIG. 2, Step 240), and “denied” if server system 155 denied the claim. A dealer and company may also log-in to the web interface and search the claims using transaction status 351. In this manner, a dealer may obtain a list of, for example, all pending claims, claims under review, claims that the dealer received payment for to update dealer accounting records, etc.

A user may select reset 353 to clear the fields in user interface 300. For example, if a user starts completing user interface 300 in anticipation of a sale, but a customer later decides not to purchase the product, the user may select reset 353. A user may select save 355 to save the claim and may select save & continue 357 to save the claim and proceed with submitting the claim to server database 155. After selecting save & continue 357, user interface 300 may present a user with a summary of the claim, any error messages, and any warnings so the user can review the claim for accuracy.

The disclosed rebate processing tool ensures the prompt receipt and processing of claims for rebates. As described herein, a dealer may generate a claim for one or more rebate programs using a web interface, submit the claim to a company, and receive automatic payment from the company when the claim is valid. Because claims may be promptly processed, a dealer may provide a rebate to customers on the invoice at the time of purchase, rather than waiting for an extended period of time to obtain the refund. In this manner, the disclosed rebate processing tool may monitor the success of rebate programs and update accounting records.

The files, information, data, and reports described herein may be assembled in any format, such as a spreadsheet (e.g., Excel® or XML files). By using a spreadsheet format, users may easily sort columns, add columns, and otherwise customize the reports. However, additional formats may also be used, including but not limited to, pie charts, bar graphs, three dimensional graphics, line graphs, and other formats. The reports may be viewed, modified, saved, and printed by a user. In addition to submitting claims, client 105 may transmit additional files, information, data, and reports to server system 155.

It will be apparent to those skilled in the art that various modifications and variations can be made to the disclosed methods for processing claims for rebate programs. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-readable medium, tangibly embodied, including a rebate processing tool, the computer-readable medium comprising instructions for:
receiving, at a computer, a claim for one or more rebate programs;
determining, by the computer, whether the claim satisfies one or more predetermined conditions;
approving the claim upon satisfaction of the predetermined conditions; and
reviewing the claim when at least one of the predetermined conditions is not satisfied.

2. The computer-readable medium of claim 1, wherein:
a company performs the receiving, determining, approving, and reviewing;
a dealer submits the claim to the company; and
the company requests correction of the claim by the dealer when the claim does not satisfy at least one of the predetermined conditions.

3. The computer-readable medium of claim 2, further including instructions for:
exchanging money between the company and the dealer after approving the claim; and
updating an accounting system to reflect the transmission.

4. The computer-readable medium of claim 1, wherein the predetermined conditions include an amount of rebate available.

5. The computer-readable medium of claim 1, further including instructions for:
displaying a list of the rebate programs;
displaying eligible rebate programs based on information included in the claim, the eligible rebate programs being a subset of the rebate programs; and
selecting one or more of the eligible rebate programs for inclusion in the claim.

6. The computer-readable medium of claim 1, further including instructions for auditing the approved claims.

7. The computer-readable medium of claim 1, further including instructions for:
generating one or more reports based on at least one of the claim and the rebate programs.

8. A method for providing a rebate processing tool, comprising:
receiving, at a computer, a claim for one or more rebate programs;
determining, by the computer, whether the claim satisfies one or more predetermined conditions;
approving the claim upon satisfaction of the predetermined conditions; and
reviewing the claim when at least one of the predetermined conditions is not satisfied.

9. The method of claim 8, wherein:
a company performs the creating, determining, approving, and reviewing;
a dealer submits the claim to the company; and
the company requests correction of the claim by the dealer when the claim does not satisfy at least one of the predetermined conditions.

10. The method of claim 9, further including:
exchanging money between the company and the dealer after approving the claim; and
updating an accounting system to reflect the transmission.

11. The method of claim 8, wherein the predetermined conditions include an amount of rebate available.

12. The method of claim 8, further including:
displaying a list of the rebate programs;
displaying eligible rebate programs based on information included in the claim, the eligible rebate programs being a subset of the rebate programs; and
selecting one or more of the eligible rebate programs for inclusion in the claim.

13. The method of claim 8, further including auditing the approved claims.

14. The method of claim 8, further including generating one or more reports based on at least one of the claim and the rebate programs.

15. A system, comprising:
a platform;
at least one input device; and
at least one central processing unit in communication with the platform and the at least one input device, the central processing unit configured to:
receive, at a computer, a claim for one or more rebate programs;
determine, by the computer, whether the claim satisfies one or more predetermined conditions;
approve the claim upon satisfaction of the predetermined conditions; and
review the claim when at least one of the predetermined conditions is not satisfied.

16. The system of claim 15, wherein:
a company performs the receiving, determining, approving, and reviewing;
a dealer submits the claim to the company; and
the company requests correction of the claim by the dealer when the claim does not satisfy at least one of the predetermined conditions.

17. The system of claim 16, wherein the central processing unit is further configured to:
exchange money between the company and the dealer after approving the claim;
update an accounting system to reflect the transmission; and
audit the approved claims.

18. The system of claim 15, wherein the predetermined conditions include an amount of rebate available.

19. The system of claim 15, wherein the central processing unit is further configured to:
display a list of the rebate programs;
display eligible rebate programs based on information included in the claim, the eligible rebate programs being a subset of the rebate programs; and
select one or more of the eligible rebate programs for inclusion in the claim.

20. The system of claim 15, wherein the central processing unit is further configured to generate one or more reports based on at least one of the claim and the rebate programs.
